(19) United States
(12) Patent Application Publication
(10) Pub. No.: US 2025/0197642 A1
(43) Pub. Date: Jun. 19, 2025

(54) PHTHALOCYANINE PIGMENT, PHTHALOCYANINE COMPOUND, COLORING COMPOSITION, METHOD FOR PRODUCING PHTHALOCYANINE PIGMENT, AND METHOD FOR PRODUCING COLORING COMPOSITION

(71) Applicant: FUJIFILM CORPORATION, Tokyo (JP)

(72) Inventors: Hirotaka SATOU, Shizuoka (JP); Sho SHIBUSAWA, Shizuoka (JP); Takayuki ITO, Shizuoka (JP); Yoshihiro JIMBO, Shizuoka (JP); Keizo KIMURA, Shizuoka (JP); Jun TANABE, Shizuoka (JP)

(21) Appl. No.: 19/070,537

(22) Filed: Mar. 5, 2025

Related U.S. Application Data
(63) Continuation of application No. PCT/JP2023/034160, filed on Sep. 20, 2023.

(30) Foreign Application Priority Data
Sep. 29, 2022 (JP) 2022-157096

(51) Int. Cl. C09B 47/18; C09D 11/033; C09D 11/037; C09D 11/322

(52) U.S. Cl. CPC C09B 47/18; C09D 11/033; C09D 11/037; C09D 11/322

(57) ABSTRACT

A phthalocyanine pigment represented by Formula (1), in which the phthalocyanine pigment has at least one diffraction peak at 3°≤2θ≤7° in a powder X-ray diffraction spectrum; a coloring composition including the phthalocyanine pigment; a method of producing a coloring composition including mixing the phthalocyanine pigment with a solvent; and the like are hereby provided.

### CROSS-REFERENCE TO RELATED APPLICATION

This application is a Continuation of International Application No. PCT/JP2023/034160, filed Sep. 20, 2023, which claims priority to Japanese Patent Application No. 2022-157096, filed Sep. 29, 2022. Each of the above applications is hereby expressly incorporated by reference, in its entirety, into the present application.

### BACKGROUND OF THE INVENTION

### 1. Field of the Invention

The present disclosure relates to a phthalocyanine pigment, a phthalocyanine compound, a coloring composition, a method for producing a phthalocyanine pigment, and a method for producing a coloring composition.

### 2. Description of the Related Art

In the related art, a coloring composition contains various pigments, dyes, and the like. For example, JP2016-141792A discloses a coloring composition containing, as a pigment, C. I. Pigment Green 58 (hereinafter, also referred to as “PG58”) having a true density of 2.985 to 3.005. In addition, WO2020/171139A discloses a coloring composition containing a dye instead of a pigment for the purpose of improving brightness.

### SUMMARY OF THE INVENTION

The pigment contained in the coloring composition is required to have various characteristics depending on the use thereof. For example, in recent years, it has been required to suppress a change in tint caused by long-time irradiation with sunlight or the like (hereinafter, also referred to as “light fastness”).

In addition, from the viewpoint of forming an image or the like satisfactorily, the pigment is required to be capable of suppressing aggregation over time (hereinafter, also referred to as “aggregation suppressiveness”). With the pigment having excellent aggregation suppressiveness, for example, in a case of being used in an ink jet or the like, jetting stability can be improved, and as a result, occurrence of a fogging or the like of an image formed by the ink jet can be suppressed.

An object to be achieved by one embodiment of the present disclosure is to provide a phthalocyanine pigment, a phthalocyanine compound, and a coloring composition, which are excellent in light fastness and aggregation suppressiveness.

An object to be achieved by another embodiment of the present disclosure is to provide a method for producing a phthalocyanine pigment and a method for producing a coloring composition, which are excellent in light fastness and aggregation suppressiveness.

The present disclosure includes the following aspects.

<1> A phthalocyanine pigment represented by Formula (1),
in which the phthalocyanine pigment has at least one diffraction peak at 3°≤2θ≤7° in a powder X-ray diffraction spectrum.

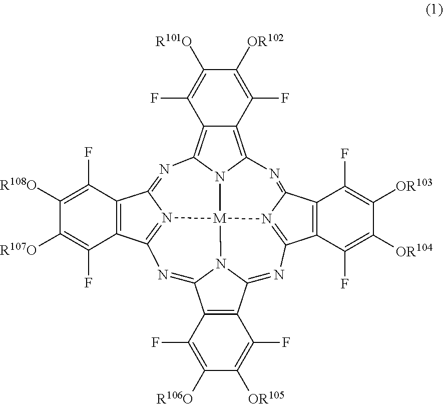

In Formula (1),
M represents zinc or copper, and
R¹⁰¹, R¹⁰², R¹⁰³, R¹⁰⁴, R¹⁰⁵, R¹⁰⁶, R¹⁰⁷, and R¹⁰⁸ each independently represent a substituted or unsubstituted alkyl group, a substituted or unsubstituted aryl group, or a substituted or unsubstituted heterocyclic group.

<2> The phthalocyanine pigment according to <1>,
in which, in Formula (1), M is zinc, and
   at least one of R¹⁰¹, R¹⁰², R¹⁰³, R¹⁰⁴, R¹⁰⁵, R¹⁰⁶, R¹⁰⁷, or R¹⁰⁸ is a group represented by Formula (2).

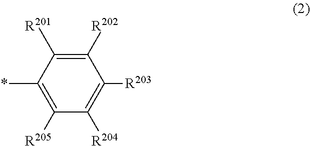

In Formula (2),
R²⁰¹, R²⁰², R²⁰³, R²⁰⁴, and R²⁰⁵ each independently represent a hydrogen atom, an alkyl group, a phenoxycarbonyl group, or an alkoxy group,
at least one of R²⁰¹, R²⁰², R²⁰³, R²⁰⁴, or R²⁰⁵ is an alkyl group, a phenoxycarbonyl group, or an alkoxy group, and
* represents a linking part to an oxygen atom.

<3> The phthalocyanine pigment according to <2>,
in which, in Formula (2), R²⁰¹, R²⁰², R²⁰⁴, and R²⁰⁵ are hydrogen atoms, and
   R²⁰³ is an alkyl group, a phenoxycarbonyl group, or an alkoxy group.

<4> The phthalocyanine pigment according to <2> or <3>,
in which, in Formula (2), R²⁰¹, R²⁰², R²⁰⁴, and R²⁰⁵ are hydrogen atoms, and
   R²⁰³ is a methyl group, an ethyl group, a propyl group, a butyl group, a methoxy group, an ethoxy group, or a propyloxy group.

<5> The phthalocyanine pigment according to any one of <1> to <4>,
in which a solubility in acetone at 25° C. is less than 0.005% by mass.
   <6> A phthalocyanine compound represented by Formula (3).

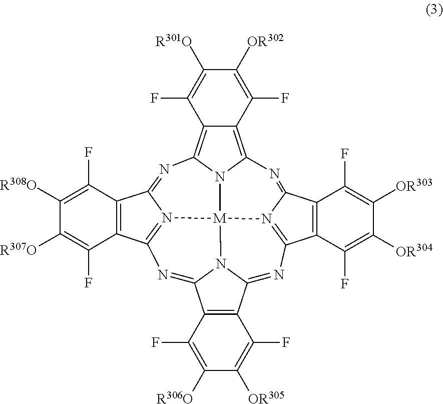

In Formula (3),
M represents zinc or copper, and
R³⁰¹, R³⁰², R³⁰³, R³⁰⁴, R³⁰⁵, R³⁰⁶, R³⁰⁷, and R³⁰⁸ each independently represent a substituted or unsubstituted alkyl group, a substituted or unsubstituted aryl group, or a substituted or unsubstituted heterocyclic group,
provided that at least one of R³⁰¹, R³⁰², R³⁰³, R³⁰⁴, R³⁰⁵, R³⁰⁶, R³⁰⁷, or R³⁰⁸ is an aryl group represented by Formula (4).

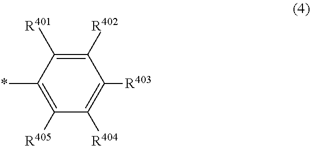

In Formula (4),
R⁴⁰¹, R⁴⁰², R⁴⁰⁴, and R⁴⁰⁵ are hydrogen atoms,
R⁴⁰³ represents a methyl group, an ethyl group, a propyl group, a butyl group, a methoxy group, an ethoxy group, or a propyloxy group, and
* represents a linking part to an oxygen atom.

<7> A coloring composition comprising:
at least one of the phthalocyanine pigment according to any one of <1> to <5> or the phthalocyanine compound according to <6>.

<8> The coloring composition according to <7>, further comprising:
a solvent having a boiling point of lower than 160° C. at 1013.2 hPa.

<9> The coloring composition according to <8>,
in which the solvent includes at least one selected from an alcohol, a ketone, a carboxylic acid ester, or an ether.

<10> The coloring composition according to <7> or <8>,
in which the solvent includes a carboxylic acid ester.

<11> The coloring composition according to any one of <7> to <10>,
in which the coloring composition contains no amide solvent, or contains an amide solvent with a content of 10% by mass or less with respect to a total mass of the coloring composition.

<12> The coloring composition according to any one of <7> to <11>, further comprising:
a dispersant.

<13> The coloring composition according to <12>,
in which the dispersant is a polymer dispersant having a weight-average molecular weight of 1,000 to 100,000.

<14> The coloring composition according to any one of <7> to <13>,
in which the coloring composition is an ink for an ink jet.

<15> A method of producing a phthalocyanine pigment, comprising:
mixing a phthalonitrile compound represented by any one Formula (5) to Formula (8), a metal salt of at least one of zinc or copper, and a solvent with each other,
in which, in the mixing, a ratio of a used amount of the solvent to a used amount of the phthalonitrile compound is 2.0 times or less on a mass basis.

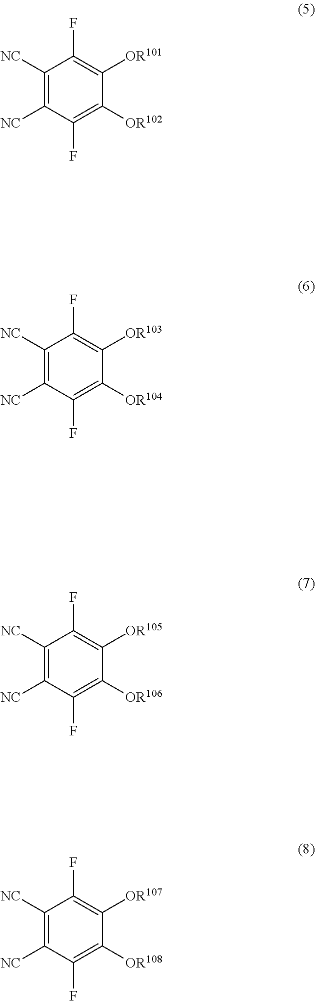

In Formula (5) to Formula (8),
R¹⁰¹, R¹⁰², R¹⁰³, R¹⁰⁴, R¹⁰⁵, R¹⁰⁶, R¹⁰⁷, and R¹⁰⁸ each independently represent a substituted or unsubstituted alkyl group, a substituted or unsubstituted aryl group, or a substituted or unsubstituted heterocyclic group.

<16> A method of producing a coloring composition, comprising:
mixing at least one of the phthalocyanine pigment according to <1> or the phthalocyanine compound according to <6> with a solvent.

<17> The method of producing a coloring composition according to <16>,
in which, in the mixing, at least one of the phthalocyanine pigment or the phthalocyanine compound is dispersed in the solvent.

According to one embodiment of the present disclosure, it is possible to provide a phthalocyanine pigment, a phthalocyanine compound, and a coloring composition, which are excellent in light fastness and aggregation suppressiveness.

According to another embodiment of the present disclosure, it is possible to provide a method for producing a phthalocyanine pigment and a method for producing a coloring composition, which are excellent in light fastness and aggregation suppressiveness.

### BRIEF DESCRIPTION OF THE DRAWINGS

FIG. 1 is an X-ray diffraction spectrum obtained by subjecting a pigment G-1 produced in Example 1 to powder X-ray diffraction.

### DESCRIPTION OF THE PREFERRED EMBODIMENTS

Hereinafter, embodiments which are examples of the present invention will be described. These descriptions and examples are only illustrative of the embodiments and do not limit the scope of the invention.

In the present disclosure, a term “to” showing a range of numerical values is used as a meaning including a lower limit value and an upper limit value disclosed before and after the term.

In a numerical range described in a stepwise manner in the present disclosure, an upper limit or a lower limit described in one numerical range may be replaced with an upper limit or a lower limit in another numerical range described in a stepwise manner. In addition, in a numerical range described in the present disclosure, an upper limit or a lower limit described in the numerical range may be replaced with a value described in an example.

In the present disclosure, “pigment” means a compound having a solubility of less than 0.01% by mass in acetone at 25° C. The above-described solubility is preferably less than 0.005% by mass.

In the present disclosure, “dye” means a compound having a solubility of 0.01% by mass or more in acetone at 25° C.

Here, the pigment and the dye have different crystallinities, and a degree of interaction between the compounds changes depending on the crystallinities, resulting in a change in solubility in a solvent. That is, even in a case of compounds having the same structure, one compound may be classified as the pigment and the other compound may be classified as the dye due to the difference in crystallinity.

As one of evaluation methods for the crystallinity, in the present disclosure, a powder X-ray diffraction spectrum is used.

Each component may contain a plurality of kinds of substances corresponding thereto.

In a case where the amount of each component in a composition is referred to, and in a case where a plurality of substances corresponding to each component in the composition are present, it means the total amount of a plurality of substances present in the composition, unless otherwise specified.

In the present disclosure, the meaning of the term “step” includes not only an independent step but also a step whose intended purpose is achieved even in a case in which the step is not clearly distinguished from other steps.

In the present disclosure, “(meth)acrylic” represents acrylic and methacrylic.

In the present disclosure, a combination of two or more preferred aspects is a more preferred aspect.

In the present disclosure, in a case where an embodiment is described with reference to the drawing, the configuration of the embodiment is not limited to the configuration shown in the drawing.

### [Phthalocyanine Pigment]

The phthalocyanine pigment according to the present disclosure has at least one diffraction peak at 3°≤2θ≤7° in a powder X-ray diffraction spectrum, and is represented by Formula (1).

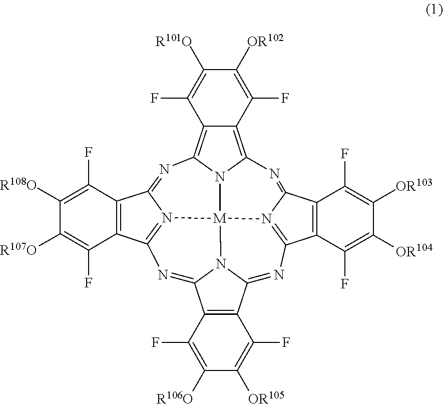

In Formula (1), M represents zinc or copper, and R¹⁰¹, R¹⁰², R¹⁰³, R¹⁰⁴, R¹⁰⁵, R¹⁰⁶, R¹⁰⁷, and R¹⁰⁸ each independently represent a substituted or unsubstituted alkyl group, a substituted or unsubstituted aryl group, or a substituted or unsubstituted heterocyclic group.

The phthalocyanine pigment according to the present disclosure has excellent light fastness and aggregation suppressiveness. The reason why the above-described effects are exhibited is not clear, but is presumed as follows.

The phthalocyanine pigment according to the present disclosure has at least one diffraction peak at 3°≤2θ≤7° in a powder X-ray diffraction spectrum. This indicates that a crystal state in which a lattice surface spacing d is large is included, and it is expected that a proportion of a phthalocyanine ring exhibiting strong association per unit area is small. Therefore, it is presumed that aggregating property between the pigments can be reduced since the influence of the π-π interaction of the phthalocyanine ring is reduced in a case where the pigment particles are close to each other.

In addition, it is presumed that the phthalocyanine pigment according to the present disclosure has excellent light fastness because the phthalocyanine pigment has a smaller surface area as a particle than the dye, and is less likely to be attacked by active oxygen or the like.

The phthalocyanine pigment according to the present disclosure has at least one diffraction peak at 3°≤2θ≤7° in a powder X-ray diffraction spectrum, but the number of diffraction peaks may be two or more.

The diffraction peak at the phthalocyanine pigment according to the present disclosure can be adjusted by adjusting a ratio of a used amount of the solvent to a used amount of the phthalonitrile compound in the production of the phthalocyanine pigment. In addition, the diffraction peak can be adjusted depending on the type of the phthalonitrile compound used.

In the present disclosure, the diffraction peak is observed as follows.
X-ray diffraction is performed under the following conditions using powder of the phthalocyanine pigment according to the present disclosure, and the number of diffraction peaks at a diffraction angle: 2θ of 3° to 7° is confirmed. As a measuring device, a known device can be used. As an example of the X-ray device, smartlab manufactured by Rigaku Corporation, D8 Discover manufactured by Bruker Corporation, Empyrean manufactured by Malvern Panalytical, and the like can be used.
In a case where the maximum peak intensity in the obtained X-ray diffraction spectrum (diffraction angle 2θ=2° to) 60° is indicated by Z, a peak having an intensity of ¼Z or more is determined as the diffraction peak.

### (Measurement Condition)

Radiation source: Cu
Diffraction angle 2θ: 2° to 60°
θ step: 0.01°

From the viewpoint of aggregation suppressiveness, it is preferable that the phthalocyanine pigment according to the present disclosure has at least one diffraction peak at 3.8°≤2θ≤6° in the powder X-ray diffraction spectrum.

In Formula (1), R¹⁰¹, R¹⁰², R¹⁰³, R¹⁰⁴, R¹⁰⁵, R¹⁰⁶, R¹⁰⁷, and R¹⁰⁸ each independently represent a substituted or unsubstituted alkyl group, a substituted or unsubstituted aryl group, or a substituted or unsubstituted heterocyclic group.

As the alkyl group, an alkyl group having 1 to 10 carbon atoms is preferable; and examples thereof include a methyl group, an ethyl group, a propyl group, and a butyl group. The alkyl group may be linear, branched, or cyclic, but is preferably linear or branched.

Examples of the aryl group include a phenyl group, a 1-naphthyl group, a 2-naphthyl group, a 1-anthryl group, a 9-anthryl group, a 2-phenanthryl group, a 3-phenanthryl group, a 9-phenanthryl group, a 1-pyrenyl group, a 5-naphthacenyl group, a 1-indenyl group, a 2-azulenyl group, a 1-acenaphthyl group, a 2-fluorenyl group, a 9-fluorenyl group, a 3-perylenyl group, an o-tolyl group, an m-tolyl group, a p-tolyl group, a 2,3-xylyl group, a 2,5-xylyl group, a mesityl group, a p-cumenyl group, a p-dodecylphenyl group, a p-cyclohexylphenyl group, a 4-biphenyl group, an o-fluorophenyl group, an m-chlorophenyl group, a p-bromophenyl group, a p-hydroxyphenyl group, an m-carboxyphenyl group, an o-mercaptophenyl group, a p-cyanophenyl group, an m-nitrophenyl group, an m-azidophenyl group.

Examples of the heterocyclic group include an imidazolyl group, a benzimidazolyl group, a pyrazolyl group, a benzopyrazolyl group, a triazolyl group, a thiazolyl group, a benzothiazolyl group, an isothiazolyl group, a benzisothiazolyl group, an oxazolyl group, a benzoxazolyl group, a thiadiazolyl group, a pyrrolyl group, a benzopyrrolyl group, an indolyl group, an isoxazolyl group, a benzisoxazolyl group, a thienyl group, a benzothienyl group, a furyl group, a benzofuryl group, a pyridyl group, a quinolyl group, an isoquinolyl group, a pyridazinyl group, a pyrimidinyl group, a pyrazinyl group, a cinnolinyl group, a phthalazinyl group, a quinazolinyl group, a quinoxalinyl group, and a triazinyl group.

In a case where the alkyl group, the aryl group, or the heterocyclic group has a substituent, examples of the substituent include an alkyl group, a hetero group, an aryl group, a halogen atom, a phenoxycarbonyl group, a phenoxyalkyl group, an acetyl group, an alkoxy group, an amide group, a sulfoalkyl group, and a sulfonamide group.

Among the above, from the viewpoint of aggregation suppressiveness of the phthalocyanine pigment according to the present disclosure, a substituted or unsubstituted aryl group is preferable, and a substituted aryl group is more preferable. From the viewpoint of aggregation suppressiveness, a substituent included in the substituted aryl group is preferably an alkyl group, a phenoxycarbonyl group, a halogen atom, an alkoxycarbonyl group, a phenyl group, or an alkoxy group; more preferably an alkyl group, a phenoxycarbonyl group, or an alkoxy group; still more preferably an alkyl group or an alkoxy group; and particularly preferably an alkyl group having 1 to 6 carbon atoms or an alkoxy group having 1 to 6 carbon atoms.

From the viewpoint of aggregation suppressiveness, in Formula (1), at least one, preferably at least two, more preferably at least three, particularly preferably at least four, and most preferably all of R¹⁰¹, R¹⁰², R¹⁰³, R¹⁰⁴, R¹⁰⁵, R¹⁰⁶, R¹⁰⁷, and R¹⁰⁸ are groups represented by Formula (2).

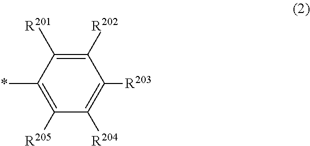

In Formula (2), R²⁰¹, R²⁰², R²⁰³, R²⁰⁴, and R²⁰⁵ each independently represent a hydrogen atom or a monovalent substituent, and * represents a linking part to an oxygen atom.

Examples of the monovalent substituent include a substituted or unsubstituted alkyl group, a substituted or unsubstituted aryl group, and a substituted or unsubstituted heterocyclic group.

From the viewpoint of aggregation suppressiveness, in Formula (2), R²⁰¹, R²⁰², R²⁰³, R²⁰⁴, and R²⁰⁵ each independently represent any one selected from a hydrogen atom, a halogen atom, a phenyl group, an alkyl group, a phenoxycarbonyl group, or an alkoxy group; and it is preferable that at least one of R²⁰¹, R²⁰², R²⁰³, R²⁰⁴, or R²⁰⁵ is an alkyl group, a phenoxycarbonyl group, or an alkoxy group, and an alkyl group or an alkoxy group is more preferable.

From the viewpoint of aggregation suppressiveness, in Formula (2), it is still more preferable that R²⁰¹, R²⁰², R²⁰⁴, and R²⁰⁵ are hydrogen atoms, and R²⁰³ represents a methyl group, an ethyl group, a propyl group, a butyl group, a methoxy group, an ethoxy group, or a propyloxy group.

An example of the phthalocyanine pigment according to the present disclosure is shown below. The phthalocyanine pigment according to the present disclosure is not limited to the following compounds. In the chemical formulae in the present disclosure, Me represents a methyl group and Ph represents a phenyl group.

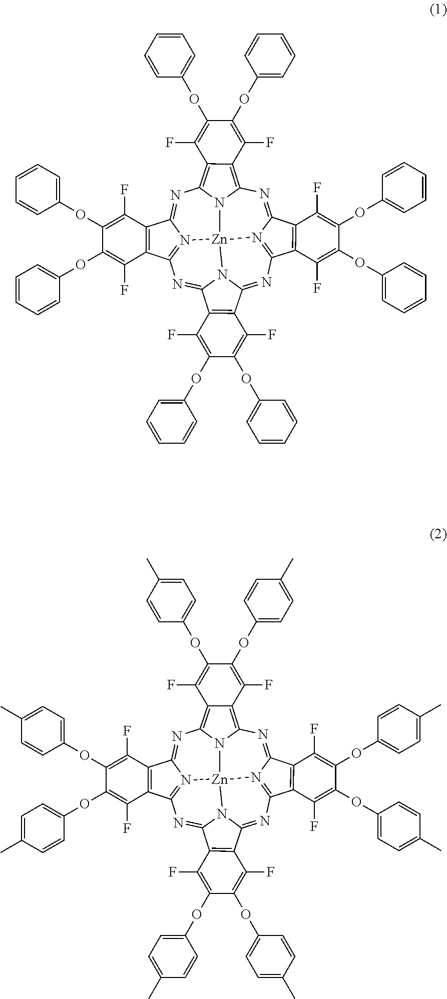

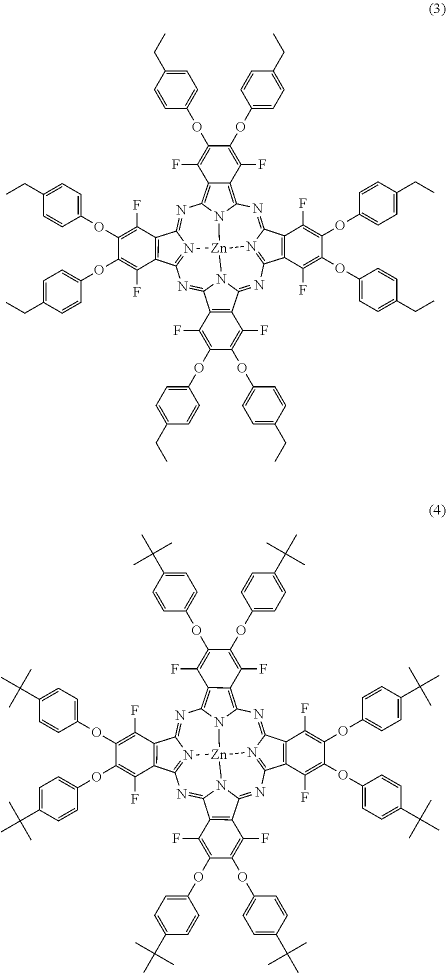

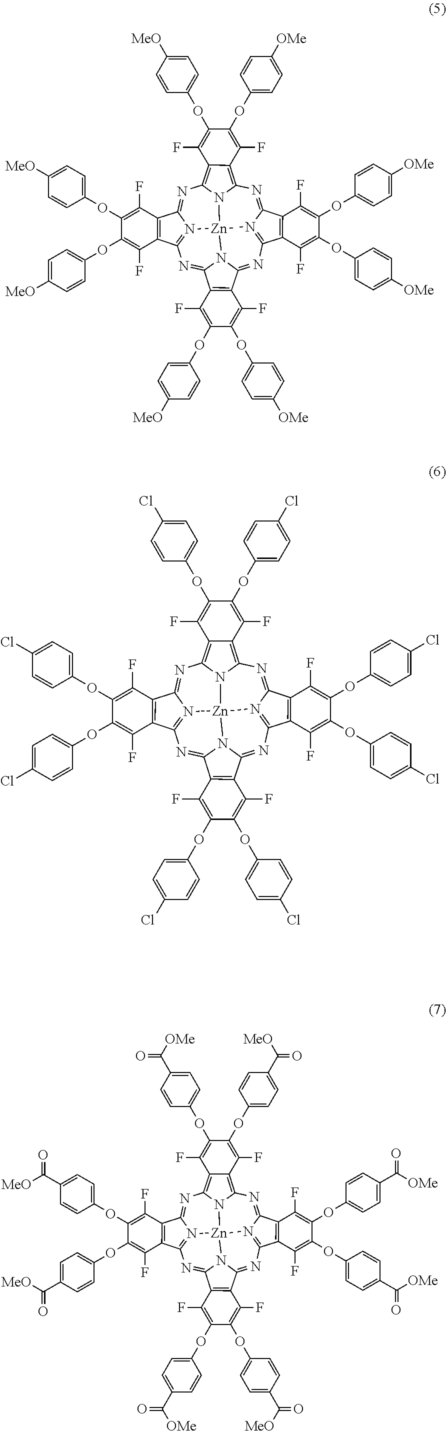

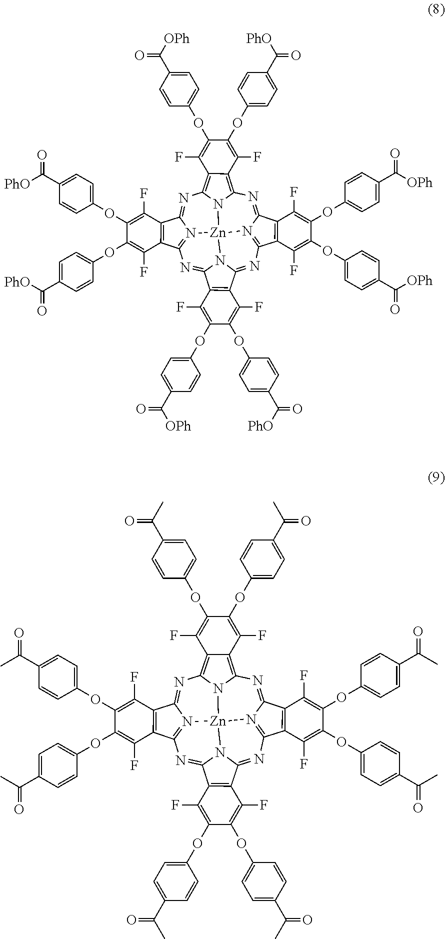

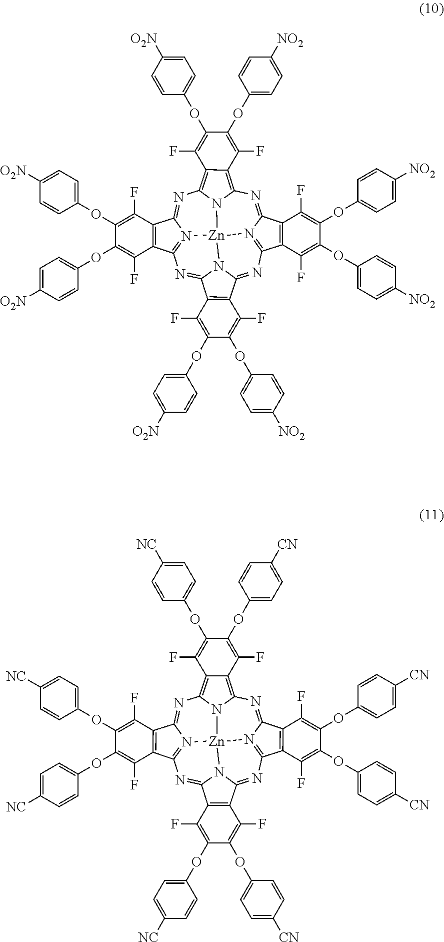

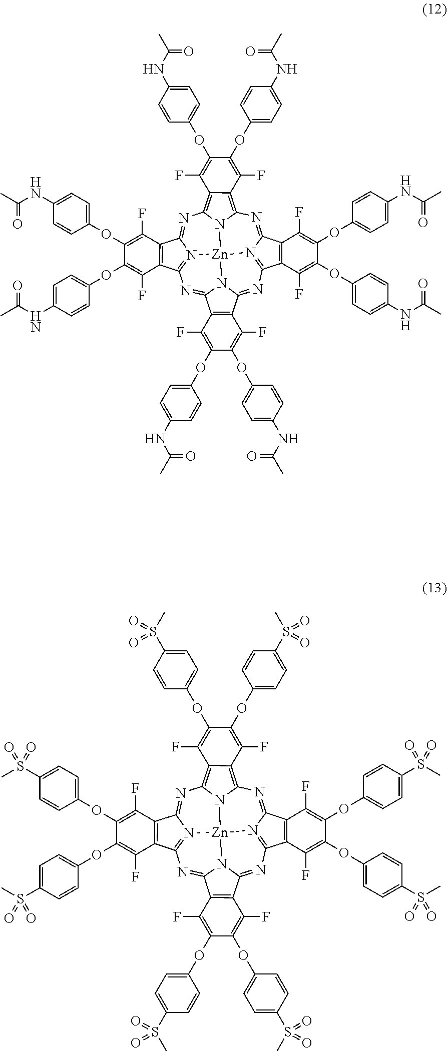

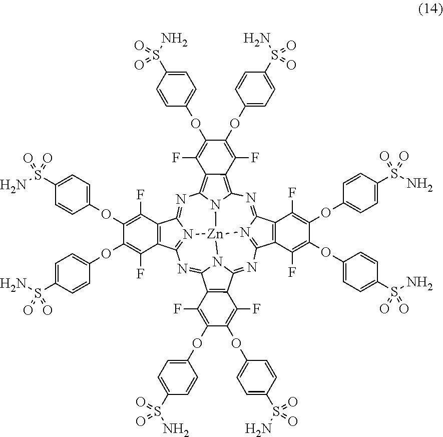

### [Phthalocyanine Compound]

The phthalocyanine compound according to the present disclosure is represented by Formula (3).

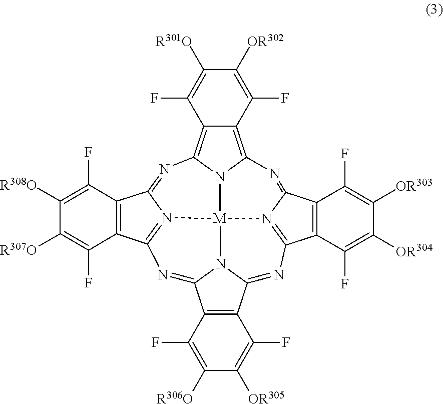

In Formula (3), M represents zinc or copper, and R³⁰¹, R³⁰², R³⁰³, R³⁰⁴, R³⁰⁵, R³⁰⁶, R³⁰⁷, and R³⁰⁸ each independently represent a substituted or unsubstituted alkyl group, a substituted or unsubstituted aryl group, or a substituted or unsubstituted heterocyclic group.

Here, at least one of R³⁰¹, R³⁰², R³⁰³, R³⁰⁴, R³⁰⁵, R³⁰⁶, R³⁰⁷, or R³⁰⁸ is an aryl group represented by Formula (4).

The alkyl group, the aryl group, and the heterocyclic group described above are the same as those for the phthalocyanine pigment according to the present disclosure, and thus the description thereof will be omitted here.

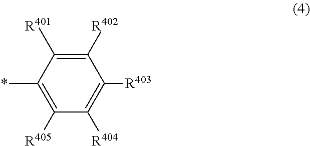

In Formula (4), R⁴⁰¹, R⁴⁰², R⁴⁰⁴, and R⁴⁰⁵ are hydrogen atoms, R⁴⁰³ represents a methyl group, an ethyl group, a propyl group, a butyl group, a methoxy group, an ethoxy group, or a propyloxy group, and * represents a linking part to an oxygen atom.

The propyl group, the butyl group, and the propoxy group may be linear or branched.

The phthalocyanine compound according to the present disclosure has excellent light fastness and aggregation suppressiveness. The reason why the above-described effects are exhibited is not clear, but is presumed as follows.

The phthalocyanine compound according to the present disclosure has a specific structure. In this manner, it is presumed that a lattice surface spacing d of the crystals is increased, and aggregating property between the pigments can be decreased.

In addition, since the phthalocyanine compound has the group represented by Formula (4), having R⁴⁰³ representing a methyl group, an ethyl group, a propyl group, a butyl group, a methoxy group, an ethoxy group, or a propyloxy group, it is presumed that the light fastness is improved since light energy is efficiently dissipated while appropriately relaxing an association and aggregation state of the phthalocyanine compound.

From the viewpoint of aggregation suppressiveness, in Formula (3), it is preferable that at least two, more preferably at least three, still more preferably at least four, and particularly preferably all of R³⁰¹, R³⁰², R³⁰³, R³⁰⁴, R³⁰⁵, R³⁰⁶, R³⁰⁷, and R³⁰⁸ are the above-described aryl groups represented by Formula (4).

A solubility of the phthalocyanine compound according to the present disclosure in acetone at 25° C. is preferably less than 0.01% by mass and more preferably less than 0.005% by mass.

Examples of the phthalocyanine compound according to the present disclosure include the compounds (2) to (5) exemplified as the phthalocyanine pigment described above. The phthalocyanine compound according to the present disclosure is not limited to the compounds.

### [Coloring Composition]

The coloring composition according to the present disclosure contains at least one of the above-described phthalocyanine pigment or the above-described phthalocyanine compound.

From the viewpoint of aggregation suppressiveness and storage stability, a viscosity of the coloring composition according to the present disclosure at 25° C. is preferably 1.0 MPa·s to 15.0 MPa·s, more preferably 2.0 MPa·s to 10.0 MPa·s, and still more preferably 3.0 MPa·s to 8.0 MPa·s.

In the present disclosure, the viscosity can be measured with a viscometer, for example, a viscometer RE85L (rotor: 1°34′×R24, measurement range: 0.6 to 1200 mPa·s) manufactured by TOKI SANGYO CO., LTD.

### (Phthalocyanine Pigment and Phthalocyanine Compound)

Since the details of the phthalocyanine pigment and the phthalocyanine compound have been described above, the description thereof will be omitted here.

The coloring composition according to the present disclosure may contain a plurality of kinds of the above-described phthalocyanine pigments and a plurality of kinds of the above-described phthalocyanine compounds. For example, the coloring composition layer may contain one or more kinds of the phthalocyanine pigments and one or more kinds of the phthalocyanine compounds, respectively, may contain a plurality of kinds of the phthalocyanine pigments having different structures from each other, or may contain a plurality of kinds of the phthalocyanine compounds having different structures from each other.

From the viewpoint of light fastness and aggregation suppressiveness, the sum of the contents of the above-described phthalocyanine pigment and the above-described phthalocyanine compound with respect to the total mass of the coloring composition is preferably 0.5% by mass to 10% by mass, more preferably 1% by mass to 8% by mass, and still more preferably 3% by mass to 6% by mass.

### (Solvent)

From the viewpoint of aggregation suppressiveness, it is preferable that the coloring composition according to the present disclosure contains a solvent having a boiling point of lower than 160° C. at 1013.2 hPa (hereinafter, also referred to as “specific solvent”). The above-described boiling point is preferably 60° C. to 158° C. and more preferably 80° C. to 150° C.

The boiling point in the present disclosure is a value measured by a boiling point meter, and can be measured using, for example, Dosa Therm300 manufactured by Titan Technologies, Inc.

Examples of the specific solvent include methyl alcohol, ethyl alcohol, butyl alcohol, isobutyl alcohol, tert-butyl alcohol, propyl alcohol, isopropyl alcohol, 1-methoxy-2-propanol, acetone, methyl ethyl ketone, methyl isobutyl ketone, cyclohexanone, propylene glycol monomethyl ether acetate, methyl acetate, ethyl acetate, propyl acetate, methyl propionate, ethyl propionate, diethyl ether, dipropyl ether, tetrahydrofuran, dioxane, and ethylene glycol methyl ether.

The coloring composition according to the present disclosure may contain a solvent other than the specific solvent (hereinafter, also referred to as “other solvents”).

The solvent can include at least one selected from water, an alcohol, a ketone, a carboxylic acid ester, or an ether.

Examples of the alcohol include methyl alcohol, ethyl alcohol, butyl alcohol, isobutyl alcohol, tert-butyl alcohol, propyl alcohol, isopropyl alcohol, 1-methoxy-2-propanol, benzyl alcohol, 1,2-hexanediol, glycerin, fluorinated alcohol, ethylene glycol, diethylene glycol, triethylene glycol, polyethylene glycol, polypropylene glycol, propylene glycol, butylene glycol, 1,2,6-hexanetriol, thioglycol, hexylene glycol, trimethylolethane, and trimethylolpropane.

Examples of the ketone include acetone, methyl ethyl ketone, methyl isobutyl ketone, and cyclohexanone.

Examples of the carboxylic acid ester include propylene glycol monomethyl ether acetate, ethyl 3-ethoxypropionate, methyl acetate, ethyl acetate, propyl acetate, methyl propionate, and ethyl propionate.

Examples of the ether include diethyl ether, dipropyl ether, tetrahydrofuran, dioxane, ethylene glycol methyl ether, ethylene glycol ethyl ether, diethylene glycol methyl ether, diethylene glycol ethyl ether, triethylene glycol monomethyl ether, and triethylene glycol monoethyl ether.

Among the above, the solvent preferably includes at least one selected from an alcohol, a ketone, or a carboxylic acid ester, and more preferably includes a carboxylic acid ester.

The coloring composition according to the present disclosure may contain only one kind of the solvent, or may contain a plurality of kinds of the solvents.

A content of the solvent with respect to the total mass of the coloring composition is preferably appropriately adjusted according to the application of the coloring composition, and for example, can be set to 1% by mass to 50% by mass.

From the viewpoint of aggregation suppressiveness, a content of the specific solvent with respect to the total mass of the solvent contained in the coloring composition according to the present disclosure is preferably 50% to 100% by mass and more preferably 80% to 100% by mass.

### (Amide Solvent)

From the viewpoint of aggregation suppressiveness, it is preferable that the coloring composition according to the present disclosure does not contain an amide solvent or contains an amide solvent with a content of 10% by mass or less with respect to the total mass of the coloring composition; it is more preferable that the coloring composition according to the present disclosure does not contain an amide solvent or contains an amide solvent with a content of 5% by mass or less with respect to the total mass of the coloring composition; it is still more preferable that the coloring composition according to the present disclosure does not contain an amide solvent or contains an amide solvent with a content of 3% by mass or less with respect to the total mass of the coloring composition; it is particularly preferable that the coloring composition according to the present disclosure does not contain an amide solvent or contains an amide solvent with a content of 1% by mass or less with respect to the total mass of the coloring composition; and it is most preferable that the coloring composition according to the present disclosure does not contain an amide solvent.

In the present disclosure, the amide solvent means a solvent having an amide bond; and examples thereof include dimethylformamide, diethylformamide, dimethylacetamide, diethylacetamide, N-methylpyrrolidone, 3-methoxy-N,N-dimethylpropanamide, hexamethylphosphoric triamide, and 1,3-dimethyl-2-imidazolidinone.

Since a compound having an amide bond, such as a yellow dye, is not the solvent, the compound is not included in the amide solvent in the present disclosure.

### (Dispersant)

From the viewpoint of aggregation suppressiveness and storage stability, the coloring composition according to the present disclosure preferably contains a dispersant.

The type of the dispersant is not particularly limited as long as the pigment can be dispersed in the coloring composition and the state thereof can be stably maintained. For example, a dispersant such as a cationic dispersant, an anionic dispersant, a nonionic dispersant, and an amphoteric dispersant can be used.

From the viewpoint of aggregation suppressiveness and storage stability, the dispersant is preferably a polymer dispersant. In the present disclosure, the polymer dispersant means a dispersant having a weight-average molecular weight of 500 or more.

Examples of the dispersant include a modified acrylic copolymer, an acrylic copolymer, polyurethane, polyester, an alkylammonium salt or a phosphate ester salt of a polymeric copolymer, and a cationic comb-shaped graft polymer.

From the viewpoint of aggregation suppressiveness and storage stability, the weight-average molecular weight of the dispersant is preferably 1,000 to 100,000, more preferably 5,000 to 50,000, and still more preferably 10,000 to 45,000.

In the present disclosure, the weight-average molecular weight is a molecular weight converted using polystyrene as a standard substance by performing detection with a gel permeation chromatography (GPC) analysis apparatus using TSKgel SuperHM-H (trade name, manufactured by Tosoh Corporation) column, a solvent of pentafluorophenol (PFP) and chloroform at a mass ratio of 1:2, and a differential refractometer, unless otherwise specified.

From the viewpoint of aggregation suppressiveness and storage stability, a content of the dispersant with respect to the total mass of the coloring composition is preferably 1% by mass to 20% by mass, more preferably 5% by mass to 15% by mass, and still more preferably 8% by mass to 13% by mass.

### (Resin)

The coloring composition according to the present disclosure may contain a resin.

Examples of the resin include an acrylic resin, a styrene-(meth)acrylic resin, a vinyl resin, polyurethane, polyester, polyamide, and a fluororesin.

Examples of the acrylic resin include a homopolymer of a monomer selected from the group consisting of (meth)acrylic acid, (meth)acrylic acid ester, (meth)acrylamide, and (meth)acrylonitrile; and a copolymer obtained by using two or more kinds of these monomers. In addition, in order to be crosslinkable with other compounds, the acrylic resin may have a functional group selected from the group consisting of a methylol group, a hydroxy group, a carboxy group, and an amino group.

Examples of the vinyl resin include polyvinyl alcohol, acid-modified polyvinyl alcohol, polyvinyl formal, polyvinyl butyral, polyvinyl methyl ether, polyolefin, an ethylene/butadiene copolymer, polyvinyl acetate, a vinyl chloride/vinyl acetate copolymer, a vinyl chloride/(meth)acrylic acid ester copolymer, and an ethylene/vinyl acetate-based copolymer.

Examples of the polyurethane include a compound obtained by reacting at least one selected from the group consisting of a polyol (for example, ethylene glycol, propylene glycol, glycerin, trimethylolpropane, and the like), a polyester polyol, a polyether polyol (for example, a poly(oxypropylene ether) polyol, a poly(oxyethylene-propylene ether) polyol, and the like), and a polycarbonate polyol with a polyisocyanate.

Examples of the polyester include a compound obtained by reacting a polyol (for example, ethylene glycol, propylene glycol, glycerin, trimethylolpropane, and the like) with a polybasic acid.

From the viewpoint of aggregation suppressiveness and storage stability, a content of the resin with respect to the total mass of the coloring composition is preferably 0.5% by mass to 20% by mass, more preferably 1% by mass to 15% by mass, and still more preferably 3% by mass to 10% by mass.

### (Additive)

The coloring composition according to the present disclosure may contain a component other than the above-described components (hereinafter, also referred to as “additive”); and examples thereof include a surfactant, colloidal silica, an inorganic salt, a solid wetting agent (urea or the like), a fading inhibitor, an emulsion stabilizer, a penetration enhancer, an ultraviolet absorber, a preservative, an antibacterial agent, a pH adjuster, an antifoaming agent, a viscosity adjuster, a dispersion stabilizer, a rust inhibitor, a chelating agent, and a water-soluble polymer compound.

### (Application)

The coloring composition according to the present disclosure can be used as an ink for an ink jet. Since the above-described phthalocyanine pigment and the above-described phthalocyanine compound contained in the coloring composition according to the present disclosure have excellent aggregation suppressiveness, jetting stability can be improved. Therefore, the coloring composition according to the present disclosure can be suitably used as an ink for an ink jet. The use of the coloring composition is not limited thereto, and the coloring composition can be used for a sheet for heat-sensitive transfer recording, an ink for printing other than the ink for an ink jet, a paint, and the like.

### [Method for Producing Phthalocyanine Pigment]

The method for producing a phthalocyanine pigment according to the present disclosure includes a mixing step of mixing a phthalonitrile compound represented by any one Formula (5) to Formula (8), a metal salt of at least one of zinc or copper, and a solvent.

In the above-described mixing step, a ratio of a used amount of the solvent to a used amount of the phthalonitrile compound (used amount of solvent/used amount of phthalonitrile compound) is 2.0 times or less on a mass basis.

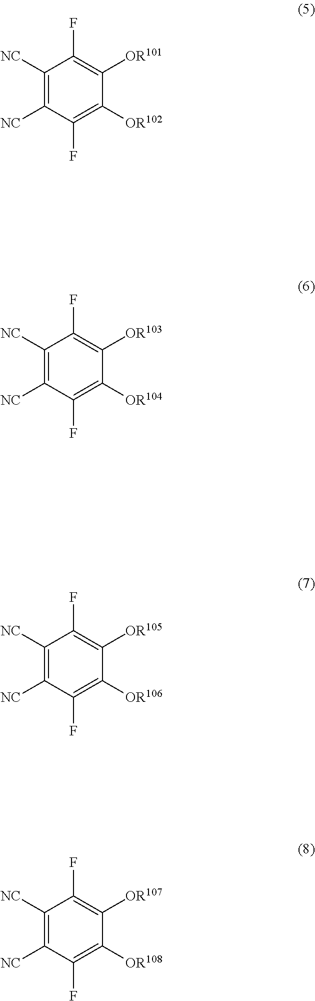

In Formula (5) to Formula (8), R¹⁰¹, R¹⁰², R¹⁰³, R¹⁰⁴, R¹⁰⁵, R¹⁰⁶, R¹⁰⁷, and R¹⁰⁸ each independently represent a substituted or unsubstituted alkyl group, a substituted or unsubstituted aryl group, or a substituted or unsubstituted heterocyclic group.

Preferred aspects of R¹⁰¹, R¹⁰², R¹⁰³, R¹⁰⁴, R¹⁰⁵, R¹⁰⁶, R¹⁰⁷, and R¹⁰⁸ are the same as those for the phthalocyanine pigment according to the present disclosure described above, and thus the description thereof will be omitted here.

The phthalonitrile compounds represented by Formula (5) to Formula (8) may be different compounds or the same compound.

The above-described phthalonitrile compounds represented by Formula (5) to Formula (8), used in the method for producing a phthalocyanine pigment according to the present disclosure, are preferably the same compound.

With the method for producing a phthalocyanine pigment according to the present disclosure, it is possible to produce a phthalocyanine pigment having excellent light fastness and aggregation suppressiveness. The reason why the above-described effects are exhibited is not clear, but is presumed as follows.

In the mixing step of the method for producing a phthalocyanine pigment according to the present disclosure, the ratio of the used amount of the solvent to the used amount of the phthalonitrile compound is set to 2.0 times or less on a mass basis. In this manner, it is presumed that, by setting the used amount of the phthalonitrile compound to be high with respect to the used amount of the solvent and performing the mixing step, it is possible to increase the lattice surface spacing d of the crystals of the obtained phthalocyanine pigment and to reduce aggregating property between the pigments.

With the method for producing a phthalocyanine pigment according to the present disclosure, it is possible to produce the above-described phthalocyanine pigment according to the present disclosure. In addition, the above-described phthalocyanine compound according to the present disclosure can also be produced with reference to this.

### (Mixing Step)

Examples of the solvent used for the synthesis of the phthalocyanine pigment include benzonitrile, nitrobenzene, chlorobenzene, dichlorobenzene, trichlorobenzene, chloronaphthalene, methylnaphthalene, pyridine, N,N-dimethylformamide, N,N-dimethylacetamide, dimethyl sulfoxide, and sulfolane.

From the viewpoint of aggregation suppressiveness, the ratio of the used amount of the solvent to the used amount of the phthalonitrile compound is preferably 1.0 times to 2.0 times, more preferably 1.2 times to 2.0 times, and still more preferably 1.5 times to 1.9 times on a mass basis.

In addition, it is preferable that the method for producing a phthalocyanine pigment according to the present disclosure is performed in an inert atmosphere.

Examples of the metal salt of zinc include zinc iodide, zinc chloride, zinc bromide, zinc acetate, and zinc stearate. Examples of the metal salt of copper include copper iodide, copper chloride, copper bromide, copper acetate, and copper stearate. Among the above, a metal salt of zinc is preferable, and zinc iodide is more preferable.

From the viewpoint of aggregation suppressiveness, a ratio of the sum of the used amounts of the metal salts of zinc and copper to the used amount of the phthalonitrile compound (sum of used amounts of metal salts of zinc and copper/used amount of phthalonitrile compound) is preferably 0.01 times to 0.6 times, more preferably 0.05 times to 0.5 times, and still more preferably 0.1 times to 0.4 times on a mass basis.

### (Heating Step)

The method for producing a phthalocyanine pigment according to the present disclosure may include a heating step of heating the mixture obtained in the above-described mixing step to precipitate crystals of the phthalocyanine pigment.

A heating method is not particularly limited, and the heating can be performed using a heating device (a heater or the like).

From the viewpoint of reactivity and aggregation suppressiveness, a heating temperature is preferably 100° C. to 250° C. and more preferably 130° C. to 200° C. In the present disclosure, the heating temperature refers to an environmental temperature at which the mixture is heated.

From the viewpoint of reactivity and aggregation suppressiveness, a heating time is, for example, preferably 3 hours to 12 hours and more preferably 4 hours to 8 hours.

### (Cooling Step)

The method for producing a phthalocyanine pigment according to the present disclosure may include a cooling step of performing cooling after the heating step.

A cooling method is not particularly limited, and may be performed using a cooling device (a blower or the like) or the like, or may be performed by air cooling.

A cooling temperature is not particularly limited, and can be, for example, 0° C. to 30° C. In the present disclosure, the cooling temperature refers to an environmental temperature at which the cooling is performed.

After the cooling, filtration or the like may be performed.

### (Milling Step)

The method for producing a phthalocyanine pigment according to the present disclosure may include a milling step in order to form fine particles of the phthalocyanine pigment according to the present disclosure.

The above-described phthalocyanine pigment according to the present disclosure may be subjected to a milling step to be formed into fine particles.

The milling step is not particularly limited, but preferably includes a salt milling step of carrying out milling using salt. The milling method may be a wet method or a dry method, but is preferably a wet method; and the milling step more preferably includes a solvent salt milling step of performing milling using salt and a solvent.

The solvent salt milling step can be performed according to a method described in paragraph 0064 of JP2013-173883A.

As an example of the solvent salt milling step, fine particles of a green phthalocyanine pigment can be obtained by, for example, charging 1 part by mass of the phthalocyanine pigment according to the present disclosure, 10 parts by mass of pulverized sodium chloride, and 2 parts by mass of diethylene glycol into a double-arm type kneader, kneading the mixture at 100° C. for 3 hours, taking out the kneaded material into 100 parts by mass of water at 80° C., and filtering and washing the kneaded material.

### [Method for Producing Coloring Composition]

The method for producing a coloring composition according to the present disclosure includes a mixing step of mixing at least one of the above-described phthalocyanine pigment according to the present disclosure or the above-described phthalocyanine compound according to the present disclosure with a solvent.

Since the phthalocyanine pigment according to the present disclosure, the phthalocyanine compound according to the present disclosure, and the solvent have been described above, the description thereof will be omitted here.

### (Mixing Step)

In the mixing step, a mixing method is not particularly limited as long as it is a mixing step of mixing at least one of the phthalocyanine pigment according to the present disclosure or the phthalocyanine compound according to the present disclosure with a solvent. In the mixing step, the above-described dispersant, the above-described resin, the above-described additive, and the like may be added in addition to the above-described components.

It is preferable that the mixing step includes a step of dispersing at least one of the above-described phthalocyanine pigment according to the present disclosure or the above-described phthalocyanine compound according to the present disclosure.

The above-described dispersion can be carried out according to a method described in paragraph 0093 of JP2013-173883A.

Specifically, at least one of the above-described phthalocyanine pigment according to the present disclosure or the above-described phthalocyanine compound according to the present disclosure can be dispersed in the solvent using a dispersion apparatus. As the dispersion apparatus, a device of a simple stirring system, an impeller stirring system, an in-line stirring system, a mill system (for example, colloid mill, ball mill, sand mill, attritor, roll mill, agitator mill, and the like), an ultrasonic system, or a high-pressure emulsifying and dispersing system (high-pressure homogenizer; specific commercial devices include Gaulin homogenizer, microfluidizer, DeBEE2000, and the like) can be used.

In the dispersion step, it is preferable to add the above-described dispersant to the above-described components to perform the dispersion.

### EXAMPLES

Hereinafter, the present disclosure will be described in detail with reference to Examples. However, the present disclosure is not limited to Examples, and the contents (for example, raw materials, conditions, and methods) described in Examples may be appropriately modified within the scope of the object of the present disclosure. In the following description, unless otherwise specified, “%” means “% by mass”.

### Example 1

Zinc iodide (1.74 g), 3,6-difluoro-4,5-bisphenoxyphthalonitrile (6.20 g), and benzonitrile (12 mL) were charged into a 100 mL eggplant flask and mixed (mixing step), and the mixture was reacted at 160° C. for 5 hours in a nitrogen atmosphere to precipitate crystals (heating step).

The inside of the eggplant flask was cooled to room temperature (25° C.) (cooling step), and the precipitated crystals were collected by filtration.

The obtained crystals were washed with 60 mL of methanol to obtain a pigment G-1 (green pigment).

A yield amount was 2.64 g, a yield rate was 41%, a solubility in acetone at 25° C. was less than 0.005% by mass, and it was confirmed that the substance was a pigment, not a dye.

The pigment G-1 was identified to be the following compound by matrix-assisted laser desorption/ionization time-of-flight mass spectrometry (MALDI-TOFMS) (MALDI-TOFMS: 1459 ([M+1]⁺)).

In the production of the above-described pigment G-1, a ratio of the used amount of the solvent to the used amount of the phthalonitrile compound used was 1.9 times on a mass basis.

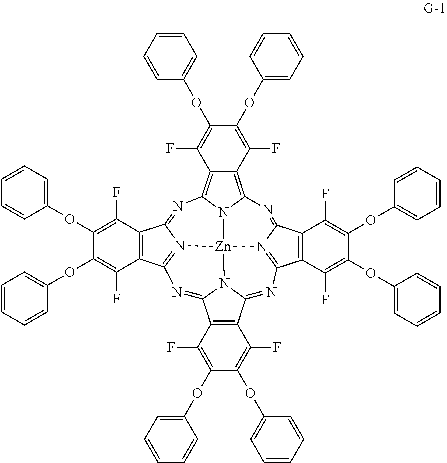

Powder X-ray diffraction was performed on the pigment G-1 under the following conditions, and the number of diffraction peaks at 3° to 7° was confirmed. Results of diffraction angles at which the peak was observed are shown in Table 1.

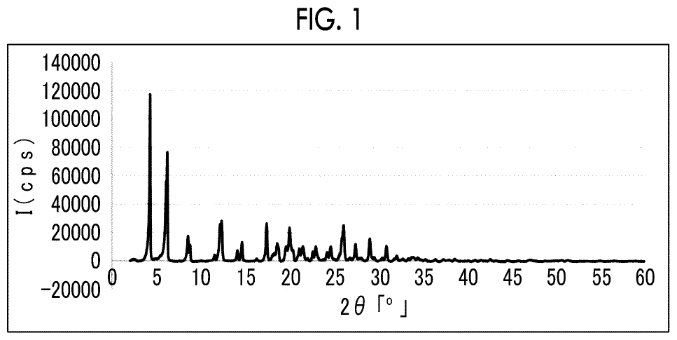

In a case where the maximum peak intensity in the obtained X-ray diffraction spectrum (diffraction angle 2θ=2° to) 60° was indicated by Z, a peak having an intensity of ¼Z or more was determined as the diffraction peak. In addition, FIG. 1 shows an X-ray diffraction spectrum obtained by subjecting the pigment G-1 to the powder X-ray diffraction.

### (Measurement Condition)

Radiation source: Cu
Diffraction angle 2θ: 2° to 60°
θ step: 0.01°

The above-described conditions were set values in an X-ray diffractometer. As the X-ray diffractometer, a known device can be used. In the present disclosure, examples of the X-ray diffractometer which can be used for the powder X-ray diffraction include SmartLab manufactured by Rigaku Corporation, D8 Discover manufactured by Bruker Corporation, and Empyrean manufactured by Malvern Panalytical.

40 parts by mass of the pigment G-1, 23 parts by mass of an acrylic resin (dispersant, average molecular weight: 23,000) synthesized with reference to [Synthesis Example 1] described in JP2016-141792A, 34 parts by mass of a 5% by mass sodium hydroxide aqueous solution, 7 parts by mass of isopropyl alcohol, and 75 parts by mass of deionized water were charged into a stainless container. Next, the pigment was dispersed for 2 hours using a paint conditioner and zirconia beads having a diameter of 0.5 mm, manufactured by Nikka Corporation, to obtain a pigment dispersion liquid 1 (mixing step).

### Example 2

Tetrafluorophthalonitrile (20.0 g), potassium fluoride (13.9 g), and acetone (72 mL) were charged into a three-neck flask, and the mixture was stirred and dissolved at 25° C.

Thereafter, the mixture was cooled, a solution obtained by dissolving p-cresol (21.6 g) in 48 mL of acetone at an internal temperature of −11° C. to −5° C. was added dropwise thereto, and the mixture was stirred for 5 hours while the temperature was gradually returned to 25° C.

Insoluble matter of the reaction solution was separated by filtration, and the filtrate was concentrated. The obtained residue was purified by silica gel column chromatography to obtain an intermediate G-2a. A yield amount was 37.6 g and a yield rate was 48%.

It was identified by MALDI-TOFMS that the intermediate G-2a was the following compound (MALDI-TOFMS: 377 ([M+1]⁺)).

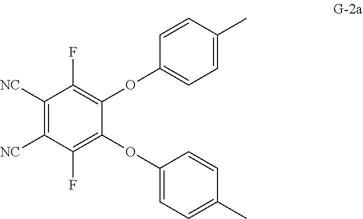 [SMILES: Cc1ccc(Oc2c(F)c(C#N)c(C#N)c(F)c2Oc2ccc(C)cc2)cc1]

A pigment G-2 (green pigment) was obtained in the same manner as in Example 1, except that 3,6-difluoro-4,5-bisphenoxyphthalonitrile in Example 1 was changed to the intermediate G-2a (15.0 g).

A yield amount was 10.3 g, a yield rate was 66%, a solubility in acetone at 25° C. was less than 0.005% by mass, and it was confirmed that the substance was a pigment, not a dye.

It was identified By MALDI-TOFMS that the pigment G-2 was the following compound (MALDI-TOFMS: 1572 ([M+1]⁺)).

In the production of the above-described pigment G-2, a ratio of the used amount of the solvent to the used amount of the phthalonitrile compound used was 1.8 times on a mass basis.

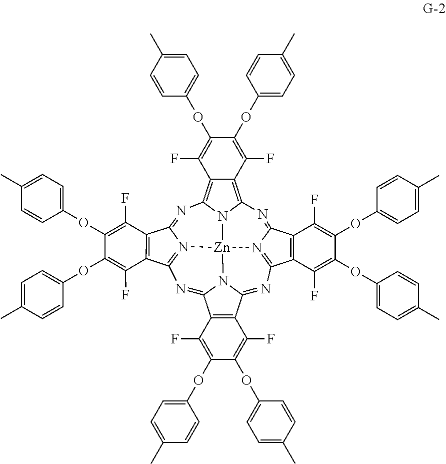

Powder X-ray diffraction was performed on the pigment G-2 in the same manner as in Example 1, and the number of diffraction peaks at 3° to 7° was confirmed. The results are shown in Table 1.

A pigment dispersion liquid 2 was obtained in the same manner as in Example 1, except that the pigment G-1 was changed to the pigment G-2.

### Example 3

14.6 g of an intermediate G-3a (yield rate: 46%) was obtained in the same manner as in Example 2, except that p-cresol in the synthesis of the intermediate G-2a of Example 2 was changed to p-ethylphenol (19.2 g).

It was identified by MALDI-TOFMS that the intermediate G-3a was the following compound (MALDI-TOFMS: 405 ([M+1]⁺)).

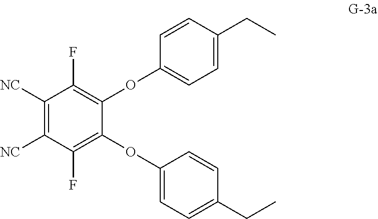 [SMILES: CCc1ccc(Oc2c(F)c(C#N)c(C#N)c(F)c2Oc2ccc(CC)cc2)cc1]

A pigment G-3 (green pigment) was obtained in the same manner as in Example 1, except that 3,6-difluoro-4,5-bisphenoxyphthalonitrile in Example 1 was changed to the intermediate G-3a (10.0 g).

A yield amount was 7.78 g, a yield rate was 75%, a solubility in acetone at 25° C. was less than 0.005% by mass, and it was confirmed that the substance was a pigment, not a dye.

It was identified By MALDI-TOFMS that the pigment G-3 was the following compound (MALDI-TOFMS: 1684 ([M+1]⁺)).

In the production of the above-described pigment G-3, a ratio of the used amount of the solvent to the used amount of the phthalonitrile compound used was 1.8 times on a mass basis.

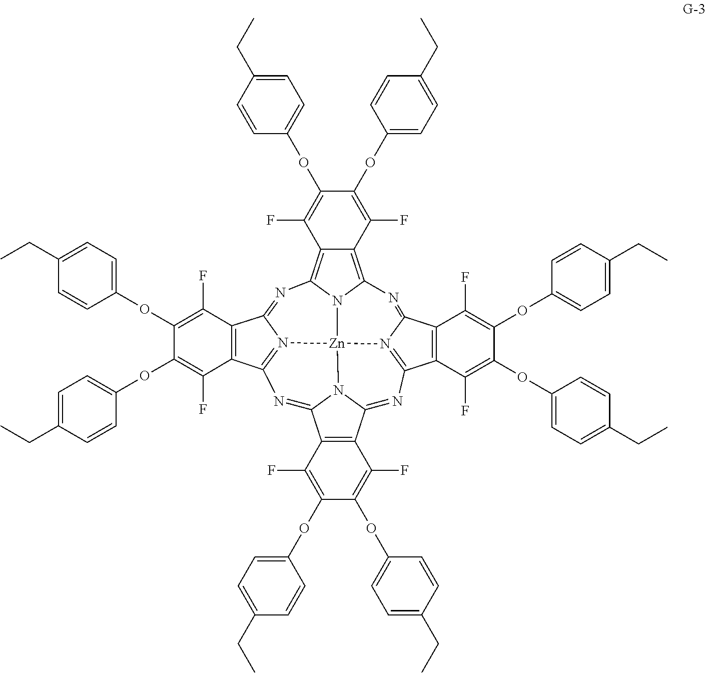

Powder X-ray diffraction was performed on the pigment G-3 in the same manner as in Example 1, and the number of diffraction peaks at 3° to 7° was confirmed. The results are shown in Table 1.

A pigment dispersion liquid 3 was obtained in the same manner as in Example 1, except that the pigment G-1 was changed to the pigment G-3.

### Example 4

A pigment G-4 (green pigment) was obtained in the same manner as in Example 1, except that 3,6-difluoro-4,5-bisphenoxyphthalonitrile was changed to 3,6-difluoro-4,5-bis [4-(1,1-dimethylethyl)phenoxy]phthalonitrile (12.0 g).

A yield amount was 8.00 g, a yield rate was 65%, a solubility in acetone at 25° C. was less than 0.005% by mass, and it was confirmed that the substance was a pigment, not a dye.

It was identified By MALDI-TOFMS that the pigment G-4 was the following compound (MALDI-TOFMS: 1908 ([M+1]⁺)).

In the production of the above-described pigment G-4, a ratio of the used amount of the solvent to the used amount of the phthalonitrile compound used was 1.9 times on a mass basis.

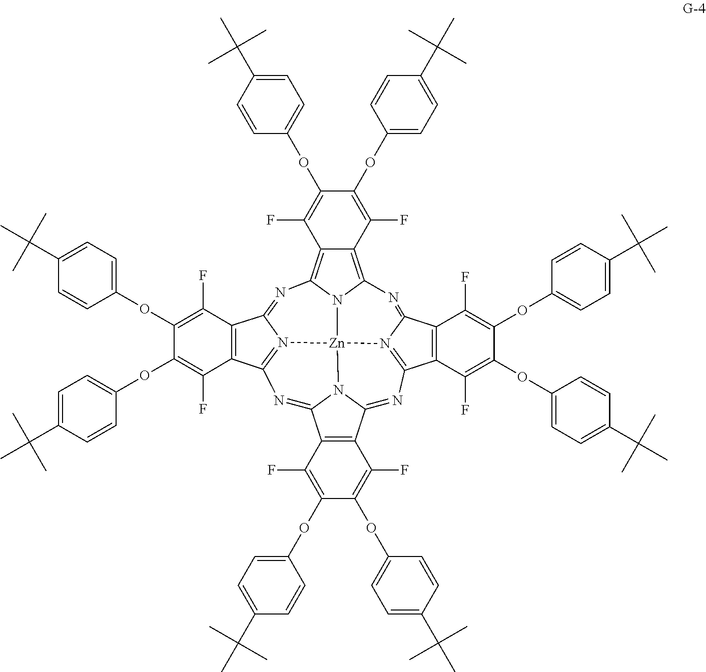

Powder X-ray diffraction was performed on the pigment G-4 in the same manner as in Example 1, and the number of diffraction peaks at 3° to 7° was confirmed. The results are shown in Table 1.

A pigment dispersion liquid 4 was obtained in the same manner as in Example 1, except that the pigment G-1 was changed to the pigment G-4.

### Example 5

8.16 g of an intermediate G-5a (yield rate: 55%) was obtained in the same manner as in Example 2, except that p-cresol in the synthesis of the intermediate G-2a of Example 2 was changed to p-methoxyphenol (9.47 g).

It was identified by MALDI-TOFMS that the intermediate G-5a was the following compound (MALDI-TOFMS: 409 ([M+1]⁺)).

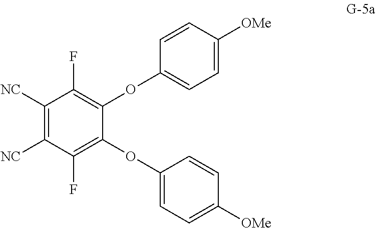 [SMILES: COc1ccc(Oc2c(F)c(C#N)c(C#N)c(F)c2Oc2ccc(OC)cc2)cc1]

A pigment G-5 (green pigment) was obtained in the same manner as in Example 1, except that 3,6-difluoro-4,5-bisphenoxyphthalonitrile in Example 1 was changed to the intermediate G-5a (8.16 g).

A yield amount was 6.71 g, a yield rate was 70%, a solubility in acetone at 25° C. was less than 0.005% by mass, and it was confirmed that the substance was a pigment, not a dye.

It was identified By MALDI-TOFMS that the pigment G-5 was the following compound (MALDI-TOFMS: 1700 ([M+1]⁺)).

In the production of the above-described pigment G-5, a ratio of the used amount of the solvent to the used amount of the phthalonitrile compound used was 1.8 times on a mass basis.

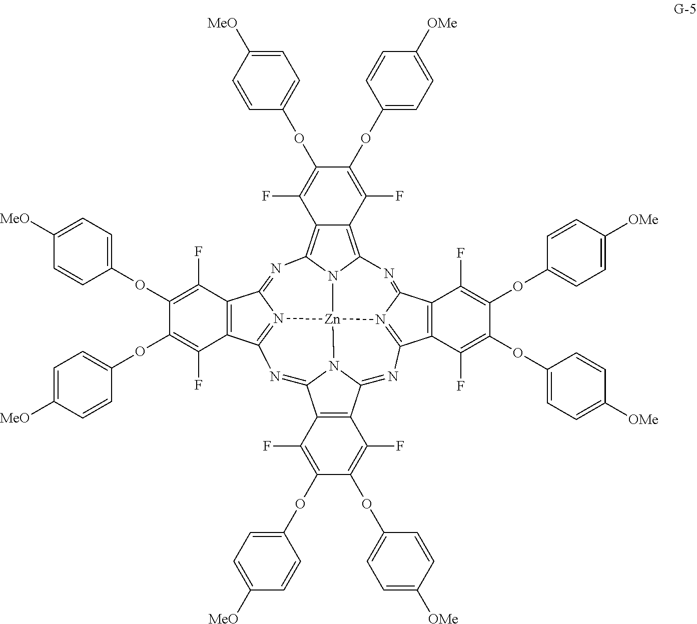

Powder X-ray diffraction was performed on the pigment G-5 in the same manner as in Example 1, and the number of diffraction peaks at 3° to 7° was confirmed. The results are shown in Table 1.

A pigment dispersion liquid 5 was obtained in the same manner as in Example 1, except that the pigment G-1 was changed to the pigment G-5.

### Example 6

A pigment G-6 (green pigment) was obtained in the same manner as in Example 1, that 3,6-difluoro-4,5-bisphenoxyphthalonitrile was changed except to 3,6-difluoro-4,5-bis(4-chlorophenoxy)phthalonitrile (6.00 g).

A yield amount was 4.43 g, a yield rate was 71%, a solubility in acetone at 25° C. was less than 0.005% by mass, and it was confirmed that the substance was a pigment, not a dye.

It was identified By MALDI-TOFMS that the pigment G-6 was the following compound (MALDI-TOFMS: 1735 ([M+1]⁺)).

In the production of the above-described pigment G-6, a ratio of the used amount of the solvent to the used amount of the phthalonitrile compound used was 1.8 times on a mass basis.

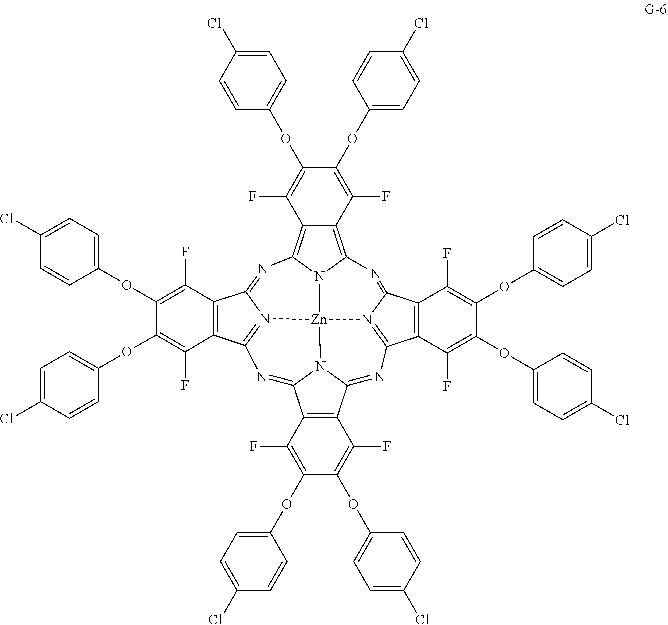

Powder X-ray diffraction was performed on the pigment G-6 in the same manner as in Example 1, and the number of diffraction peaks at 3° to 7° was confirmed. The results are shown in Table 1.

A pigment dispersion liquid 6 was obtained in the same manner as in Example 1, except that the pigment G-1 was changed to the pigment G-6.

### Example 7

A pigment G-7 (green pigment) was obtained in the same manner as in Example 1, except that 3,6-difluoro-4,5-bisphenoxyphthalonitrile was changed to 3,6-difluoro-4,5-bis(4-methoxycarbonylphenoxy)phthalonitrile (1.40 g).

A yield amount was 0.810 g, a yield rate was 56%, a solubility in acetone at 25° C. was less than 0.005% by mass, and it was confirmed that the substance was a pigment, not a dye.

It was identified By MALDI-TOFMS that the pigment G-7 was the following compound (MALDI-TOFMS: 1924 ([M+1]⁺)).

In the production of the above-described pigment G-7, a ratio of the used amount of the solvent to the used amount of the phthalonitrile compound used was 1.9 times on a mass basis.

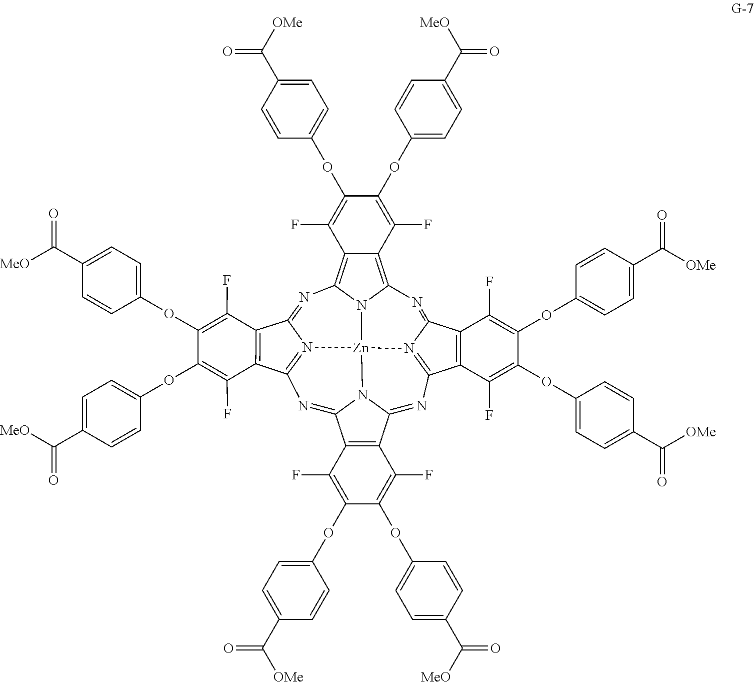

Powder X-ray diffraction was performed on the pigment G-7 in the same manner as in Example 1, and the number of diffraction peaks at 3° to 7° was confirmed. The results are shown in Table 1.

A pigment dispersion liquid 7 was obtained in the same manner as in Example 1, except that the pigment G-1 was changed to the pigment G-7.

### Example 8

3,6-Difluoro-4,5-bis(4-phenoxycarbonylphenoxy)phthalonitrile (2.00 g) and benzonitrile (4 mL) were charged into a 100 mL eggplant flask, and the mixture was stirred at 125° C. for 1 hour in a nitrogen atmosphere.

Subsequently, zinc iodide (0.326 g) was added thereto, and the mixture was stirred at 170° C. for 4 hours to carry out a reaction, thereby precipitating crystals. The inside of the eggplant flask was cooled to 25° C. and filtered, and the obtained crystals were washed with 50 mL of benzonitrile to obtain a pigment G-8 (green pigment).

A yield amount was 0.246 g, a yield rate was 10%, a solubility in acetone at 25° C. was less than 0.005% by mass, and it was confirmed that the substance was a pigment, not a dye.

It was identified By MALDI-TOFMS that the pigment G-8 was the following compound (MALDI-TOFMS: 2420 ([M+1]⁺)).

In the production of the above-described pigment G-8, a ratio of the used amount of the solvent to the used amount of the phthalonitrile compound used was 2.0 times on a mass basis.

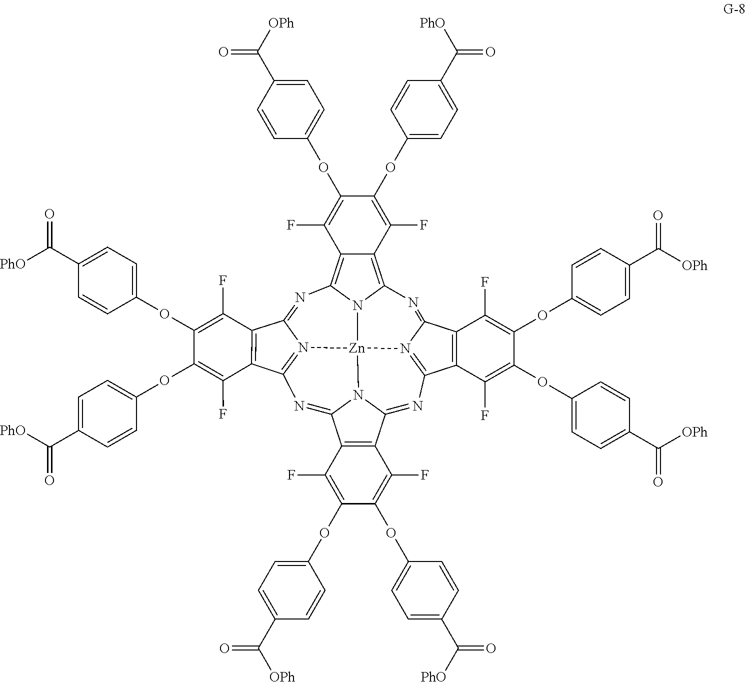

Powder X-ray diffraction was performed on the pigment G-8 in the same manner as in Example 1, and the number of diffraction peaks at 3° to 7° was confirmed. The results are shown in Table 1.

A pigment dispersion liquid 8 was obtained in the same manner as in Example 1, except that the pigment G-1 was changed to the pigment G-8.

### Comparative Example 1

C. I. Pigment Green 58 (hereinafter, also referred to as “PG58”) was prepared. The structure of PG58 is shown below. For PG58, a solubility in acetone at 25° C. was less than 0.005% by mass, and it was confirmed that the substance was a pigment, not a dye.

A pigment dispersion liquid A was obtained in the same manner as in Example 1, except that the pigment G-1 was changed to PG58.

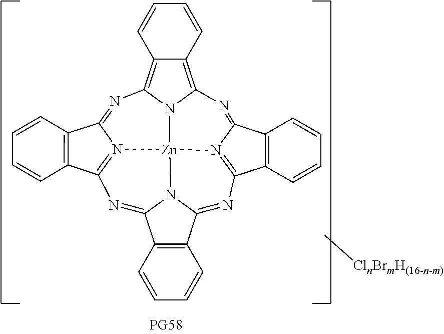

### Comparative Example 2

The following compound G-9 was synthesized based on Example 30 of JP1993-345861A (JP-H05-345861A). A solubility in acetone at 25° C. was 5% by mass, and it was confirmed that the substance was a dye.

In a case where powder X-ray diffraction was performed on the compound G-9 in the same manner as in Example 1, no peak was observed at a diffraction angle 20:2° to 60°.

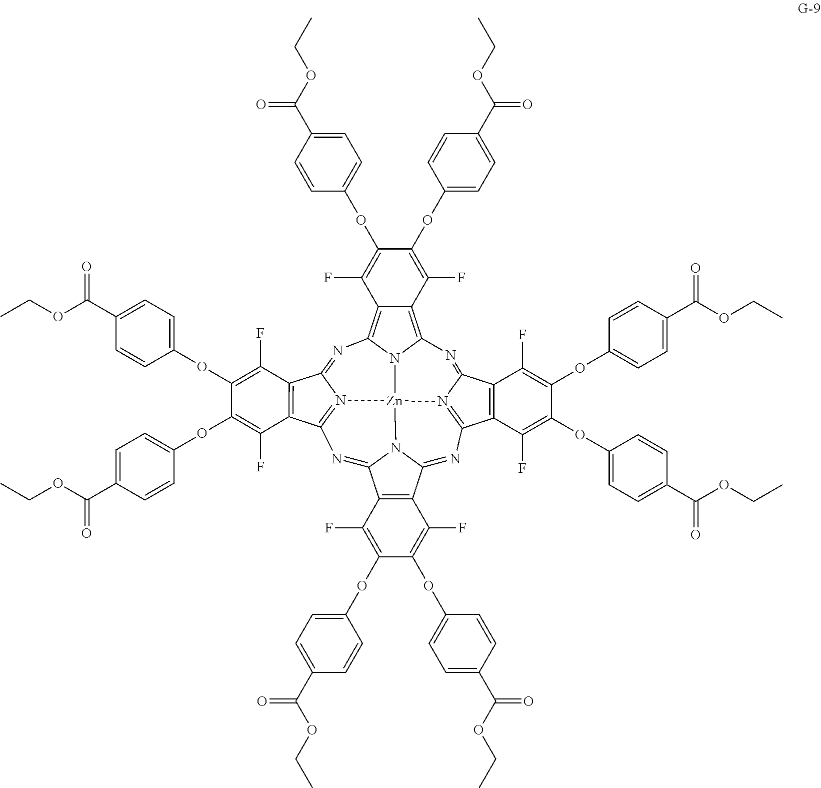

### Comparative Example 3

3,6-Difluoro-4,5-bis(4-phenoxycarbonylphenoxy)phthalonitrile (6.50 g) and benzonitrile (26 mL) were charged into a 100 mL eggplant flask, and the mixture was stirred at 120° C. for 1 hour in a nitrogen atmosphere.

Subsequently, zinc iodide (1.06 g) was added thereto, the mixture was stirred at 140° C. for 2 hours, and further stirred at 170° C. for 9 hours to proceed with the reaction. The inside of the eggplant flask was cooled to 25° C., and crystals were re-precipitated with 60 mL of methanol, and the precipitated crystals were collected by filtration.

The obtained crystals were purified by silica gel column chromatography (developing solvent: ethyl acetate/hexane=1/1, [v/v]) to obtain a compound G-10.

A yield amount was 3.02 g, a yield rate was 45%, a solubility in acetone at 25° C. was 2.0% by mass, and it was confirmed that the substance was a dye.

It was identified By MALDI-TOFMS that the compound G-10 was a compound having the same structure as the pigment G-8 (MALDI-TOFMS: 2420 ([M+1]⁺)).

In the production of the above-described compound G-10, a ratio of the used amount of the solvent to the used amount of the phthalonitrile compound used was 4.0 times on a mass basis.

In a case where powder X-ray diffraction was performed on the compound G-10 in the same manner as in Example 1, no peak was observed at a diffraction angle 2θ: 2° to 60°

### <<Evaluation of Light Fastness>>

The pigment dispersion liquid 1, a polyurethane resin (HYDRAN (registered trademark) AP-40F (manufactured by DIC Corporation)), and deionized water were mixed to produce an aqueous pigment dispersion liquid 1 having a pigment content of 10% by mass and a polyurethane resin non-volatile content of 2% by mass.

The following components were mixed to obtain a coloring composition 1.

### (Formulation of Coloring Composition 1)

| | | |
|---|---|---|
| Aqueous pigment dispersion liquid 1 (non-volatile | 40 | parts by mass |
| content: 4.5% by mass) | | |
| 1,2-Hexanediol | 5 | parts by mass |
| Glycerin | 10 | parts by mass |
| SURFYNOL 465 (surfactant, manufactured by Air | 1 | part by mass |
| Products and Chemicals, Inc.) | | |
| Deionized water | 44 | parts by mass |

Coloring compositions 2 to 8 were obtained in the same manner as in the above-described method, except that the pigment dispersion liquid 1 was changed to each of the pigment dispersion liquids 2 to 8.

A coloring composition A was obtained in the same manner as in the above-described method, except that the pigment dispersion liquid 1 was changed to the pigment dispersion liquid A.

A coloring composition B was obtained in the same manner as in the above-described method, except that the aqueous pigment dispersion liquid 1 was changed to the compound G-9.

A coloring composition C was obtained in the same manner as in the above-described method, except that the aqueous pigment dispersion liquid 1 was changed to the compound G-10.

An image was formed on art paper using the coloring compositions 1 to 8 and the coloring compositions A to C with an ink jet printer (manufactured by FUJIFILM Corporation, trade name: MATERIAL PRINTER DMP-2850).

The above-described image was irradiated with xenon light (85,000 lux) for 100 hours using a weather meter (manufactured by Atlas, Ci65), and a reflection density after the irradiation with xenon light was measured using a reflection densitometer (manufactured by X-Rite, Inc., trade name: X-Rite i1Pro).

A reflection density of the image before the irradiation with xenon light was set to 1.0.

A compound residual rate (%) before and after the irradiation with xenon light was calculated from the following expression, and evaluated based on the following evaluation standard. The evaluation results are summarized in Table 1.

As the compound residual rate (%) is higher, the light fastness of the phthalocyanine compound contained in the image is more excellent.

$$Compound residual rate ( \% ) = ( Reflection density of solid image after irradiation with xenon light \text{)/(} Reflection density of solid image before irradiation with xenon light = 1. ) \times 100$$

### (Evaluation Standard)

A: compound residual rate was 80% or more.
B: compound residual rate was 70% or more and less than 80%.
C: compound residual rate was less than 70%.

### <<Evaluation of Aggregation Suppressiveness>>

Using the coloring compositions 1 to 8 and the coloring compositions A to C, an image was formed on 100 sheets of paper (A4 size) by the ink jet printer used in the evaluation of light fastness described above.

The formed image was visually observed, and evaluated based on the following evaluation standard. The evaluation results are summarized in Table 1.

### (Evaluation Standard)

A: in the images formed on 100 sheets of paper, no disorder such as blurring was observed.
B: in the images formed on 100 sheets of paper, slight disorders such as blurring were observed.
C: in the image formed on 100 sheets of paper, disorders such as blurring were observed.
D: in the images formed on 100 sheets of paper, many disorders such as blurring were observed.

### <<Evaluation of Storage Stability>>

In an environment of 45° C. by an oven, the coloring compositions 1 to 8 and the coloring compositions A to C were stored for 7 days.

A viscosity of the coloring composition before and after the storage was measured, a viscosity increase proportion (Viscosity after storage−Viscosity before storage)/Viscosity before storage×100 was determined, and the evaluation was performed based on the following evaluation standard. The evaluation results are summarized in Table 1.

The viscosity of the coloring composition was measured using a viscometer RE85L (rotor: 1°34′×R24, measurement range: 0.6 to 1200 mPa·s) manufactured by TOKI-SANGYO Co., Ltd. in a state in which the temperature was adjusted to 25° C.

### (Evaluation Standard)

A: viscosity increase proportion was 10% or less.
B: viscosity increase proportion was more than 10%.

TABLE 1

| | | | | Presence or | | | |
|---|---|---|---|---|---|---|---|
| | | | Diffraction | absence of | | Evaluation of | Evaluation of |
| | | | peaks at | diffraction peaks | Evaluation of | aggregation | storage |
| | Type | | 2° to 60° | at 3° to 7° | light fastness | suppressiveness | stability |
| Example 1 | G-1 | Pigment | 4.26° | Y | A | B | A |
| | | | 6.06° | | | | |
| | | | 6.20° | | | | |
| Example 2 | G-2 | Pigment | 4.32° | Y | A | A | A |
| | | | 6.05° | | | | |
| Example 3 | G-3 | Pigment | 5.50° | Y | A | A | A |
| Example 4 | G-4 | Pigment | 3.91° | Y | A | A | A |
| | | | 4.13° | | | | |
| | | | 4.50° | | | | |
| Example 5 | G-5 | Pigment | 4.20° | Y | A | A | A |
| | | | 5.71° | | | | |
| Example 6 | G-6 | Pigment | 3.93° | Y | A | A | A |
| | | | 4.14° | | | | |
| | | | 4.29° | | | | |
| | | | 4.36° | | | | |
| | | | 5.37° | | | | |
| | | | 5.93° | | | | |
| Example 7 | G-7 | Pigment | 3.99° | Y | A | A | A |
| | | | 5.28° | | | | |
| | | | 5.30° | | | | |
| Example 8 | G-8 | Pigment | 4.02° | Y | A | A | A |
| | | | 5.78° | | | | |
| Comparative | PG58 | Pigment | 25.5° | N | A | C | B |
| Example 1 | | | 26.4° | | | | |
| Comparative | G-9 | Dye | — | N | C | B | A |
| Example 2 | | | | | | | |
| Comparative | G-10 | Dye | — | N | C | B | A |
| Example 3 | | | | | | | |

### Example 9

20 parts by mass of the pigment G-1, 10 parts by mass of SOLSPERSE (registered trademark) 32000 (polymer dispersant, manufactured by Lubrizol Corporation, weight-average molecular weight: 32,000), and 70 parts by mass of propylene glycol monomethyl ether acetate (solvent) were mixed, the mixture was filled with zirconia beads having a diameter of 0.5 mm, and the mixture was dispersed for 2 hours using a ball mill to obtain a pigment dispersion liquid 1A.

### Example 10

A pigment dispersion liquid 5A was obtained in the same manner as in Example 9, except that the pigment G-1 was changed to the pigment G-5.

### Example 11

A pigment dispersion liquid 1B was obtained in the same manner as in Example 9, except that propylene glycol monomethyl ether acetate was changed to ethyl 3-ethoxypropionate.

### Example 12

20 parts by mass of the pigment G-1, 10 parts by mass of SOLSPERSE (registered trademark) 32000 (polymer dispersant, manufactured by Lubrizol Corporation, weight-average molecular weight: 32,000), 70 parts by mass of propylene glycol monomethyl ether acetate (solvent), and 7 parts by mass of N-methylpyrrolidone (amide solvent) were mixed, the mixture was filled with zirconia beads having a diameter of 0.5 mm, and the mixture was dispersed for 2 hours using a ball mill to obtain a pigment dispersion liquid 1C.

### <<Evaluation>>

The light fastness, the aggregation suppressiveness, and the storage stability for the pigment dispersion liquid 1A, the pigment dispersion liquid 5A, the pigment dispersion liquid 1B, and the pigment dispersion liquid 1C were evaluated in the same manner as described above. The results are shown in Table 2.

TABLE 2

| | | | | Presence or | | | | |
|---|---|---|---|---|---|---|---|---|
| | | | Diffraction | absence of | | Evaluation | Evaluation of | Evaluation |
| | | | peaks at | diffraction peaks | Containing | of light | aggregation | of storage |
| | Type | | 2° to 60° | at 3° to 7° | of dispersant | fastness | suppressiveness | stability |
| Example 9 | G-1 | Pigment | 4.26° | Y | Y | A | A | A |
| | | | 6.06° | | | | | |
| | | | 6.20° | | | | | |
| Example 10 | G-5 | Pigment | 4.20° | Y | Y | A | A | A |
| | | | 5.71° | | | | | |
| Example 11 | G-1 | Pigment | 4.26° | Y | Y | A | B | A |
| | | | 6.06° | | | | | |
| | | | 6.20° | | | | | |
| Example 12 | G-1 | Pigment | 4.26° | Y | Y | A | B | B |
| | | | 6.06° | | | | | |
| | | | 6.20° | | | | | |

The disclosure of JP2022-157096 filed on Sep. 29, 2022 is incorporated in the present disclosure by reference.

All documents, patent applications, and technical standards described in the present disclosure are incorporated herein by reference to the same extent as in a case of being specifically and individually noted that individual documents, patent applications, and technical standards are incorporated by reference.

What is claimed is:

1. A phthalocyanine pigment, having at least one diffraction peak at 3°≤2θ≤7° in a powder X-ray diffraction spectrum and being represented by the following Formula (1): 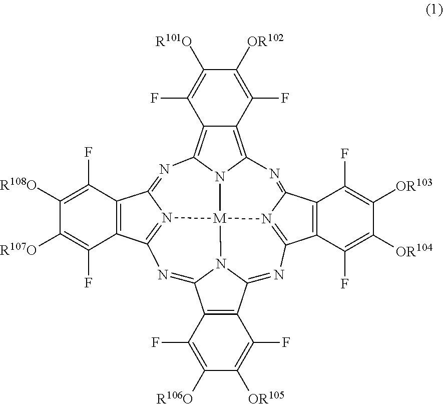
wherein in Formula (1), M represents zinc or copper; and R¹⁰¹, R¹⁰², R¹⁰³, R¹⁰⁴, R¹⁰⁵, R¹⁰⁶, R¹⁰⁷, and R¹⁰⁸ each independently represent a substituted or unsubstituted alkyl group, a substituted or unsubstituted aryl group, or a substituted or unsubstituted heterocyclic group.

2. The phthalocyanine pigment according to claim 1, wherein in Formula (1), M is zinc; and at least one of R¹⁰¹, R¹⁰², R¹⁰³, R¹⁰⁴, R¹⁰⁵, R¹⁰⁶, R¹⁰⁷, or R¹⁰⁸ is a group represented by the following Formula (2): 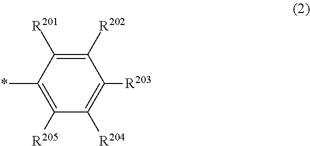
wherein in Formula (2), R²⁰¹, R²⁰², R²⁰³, R²⁰⁴, and R²⁰⁵ each independently represent a hydrogen atom, an alkyl group, a phenoxycarbonyl group, or an alkoxy group; at least one of R²⁰¹, R²⁰², R²⁰³, R²⁰⁴, or R²⁰⁵ is an alkyl group, a phenoxycarbonyl group, or an alkoxy group; and * represents a linking part to an oxygen atom.

3. The phthalocyanine pigment according to claim 2, wherein, in Formula (2), R²⁰¹, R²⁰², R²⁰⁴, and R²⁰⁵ are hydrogen atoms, and R²⁰³ is an alkyl group, a phenoxycarbonyl group, or an alkoxy group.

4. The phthalocyanine pigment according to claim 2, wherein, in Formula (2), R²⁰¹, R²⁰², R²⁰⁴, and R²⁰⁵ are hydrogen atoms, and R²⁰³ is a methyl group, an ethyl group, a propyl group, a butyl group, a methoxy group, an ethoxy group, or a propyloxy group.

5. The phthalocyanine pigment according to claim 1, wherein the phthalocyanine pigment has a solubility in acetone at 25° C. of less than 0.005% by mass.

6. A phthalocyanine compound represented by the following Formula (3): 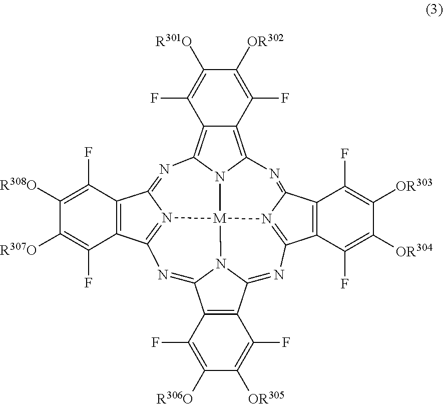
wherein in Formula (3), M represents zinc or copper; and R³⁰¹, R³⁰², R³⁰³, R³⁰⁴, R³⁰⁵, R³⁰⁶, R³⁰⁷, and R³⁰⁸ each independently represent a substituted or unsubstituted alkyl group, a substituted or unsubstituted aryl group, or a substituted or unsubstituted heterocyclic group,
provided that at least one of R³⁰¹, R³⁰², R³⁰³, R³⁰⁴, R³⁰⁵, R³⁰⁶, R³⁰⁷, or R³⁰⁸ is an aryl group represented by the following Formula (4): 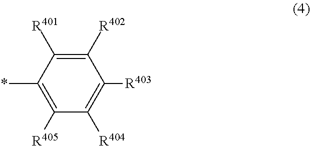
wherein in Formula (4), R⁴⁰¹, R⁴⁰², R⁴⁰⁴, and R⁴⁰⁵ are hydrogen atoms; R⁴⁰³ represents a methyl group, an ethyl group, a propyl group, a butyl group, a methoxy group, an ethoxy group, or a propyloxy group; and * represents a linking part to an oxygen atom.

7. A coloring composition comprising the phthalocyanine pigment according to claim 1.

8. The coloring composition according to claim 7, further comprising a solvent having a boiling point of lower than 160° C. at 1013.2 hPa.

9. The coloring composition according to claim 8, wherein the solvent includes at least one selected from an alcohol, a ketone, a carboxylic acid ester, or an ether.

10. The coloring composition according to claim 8, wherein the solvent includes a carboxylic acid ester.

11. The coloring composition according to claim 7, wherein the coloring composition contains no amide solvent, or contains an amide solvent with a content of 10% by mass or less with respect to a total mass of the coloring composition.

12. The coloring composition according to claim 7, further comprising a dispersant.

13. The coloring composition according to claim 12, wherein the dispersant is a polymer dispersant having a weight-average molecular weight of 1,000 to 100,000.

14. A coloring composition comprising the phthalocyanine compound according to claim 6.

15. The coloring composition according to claim 14, further comprising a solvent having a boiling point of lower than 160° C. at 1013.2 hPa.

16. A method of producing a phthalocyanine pigment, comprising mixing a phthalonitrile compound represented by any one of the following Formula (5) to Formula (8), a metal salt of at least one of zinc or copper, and a solvent with each other, wherein, in the mixing, a ratio of a used amount of the solvent to a used amount of the phthalonitrile compound is 2.0 times or less on a mass basis: 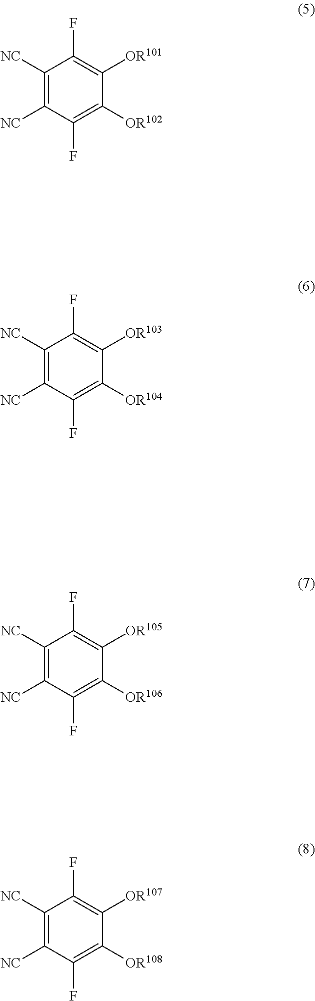
wherein in Formula (5) to Formula (8), R¹⁰¹, R¹⁰², R¹⁰³, R¹⁰⁴, R¹⁰⁵, R¹⁰⁶, R¹⁰⁷, and R¹⁰⁸ each independently represent a substituted or unsubstituted alkyl group, a substituted or unsubstituted aryl group, or a substituted or unsubstituted heterocyclic group.

17. A method of producing a coloring composition, comprising mixing the phthalocyanine pigment according to claim 1 with a solvent.

18. The method of producing a coloring composition according to claim 17, wherein the mixing comprises dispersing the phthalocyanine pigment in the solvent.

19. A method of producing a coloring composition, comprising mixing the phthalocyanine compound according to claim 6 with a solvent.

20. The method of producing a coloring composition according to claim 19, wherein the mixing comprises dispersing the phthalocyanine compound in the solvent.
